(19) United States
(12) Patent Application Publication
(10) Pub. No.: US 2025/0307112 A1
(43) Pub. Date: Oct. 2, 2025

(54) CONCURRENT METRIC MEASUREMENT AND REPORTING FOR PARALLEL EXECUTION OF A WORKLOAD

(71) Applicant: Lenovo Enterprise Solutions (Singapore) Pte. Ltd., New Tech Park (SG)

(72) Inventors: Jiali Cheng, Apex, NC (US); Tianyi Gao, Greensboro, NC (US); Jianfeng Guo, Cary, NC (US); Jun Liu, San Jose, CA (US)

(21) Appl. No.: 18/622,743

(22) Filed: Mar. 29, 2024

(51) Int. Cl. G06F 11/34

(52) U.S. Cl. CPC G06F 11/3476

(57) ABSTRACT

A method includes measuring a plurality of n metrics for a plurality of m processors executing portions of a workload in parallel. The measuring includes measuring, for a first processor of the plurality of m processors, a plurality of n metrics in a first sequence of a plurality of n sequences. The first sequence begins with a starting metric of the plurality of n metrics and ends with an nth metric. The measuring also includes measuring, for each remaining processor of the plurality of m processors, the plurality of n metrics in a sequence of the plurality of n sequences. Each progressive sequence of the plurality of n sequences begins with a progressive metric of the plurality of n metrics immediately subsequent to an immediately preceding sequence's starting metric of the plurality of n metrics. The method includes reporting the plurality of n metrics.

### FIELD

The subject matter disclosed herein relates to measurement of various metrics for a computing device and more particularly relates to concurrent measurement of various metrics and reporting for parallel execution of a workload.

### BACKGROUND

Modern processors, such as graphics processing units (“GPUs”) can execute workloads in parallel to help improve efficiency and capacity to handle complex workloads. Dividing a workload into tasks and executing those tasks concurrently helps to improve processor performance. Measuring metrics for those processors as they are executing the workload can help to further improve performance. However, measuring numerous metrics at the same time for each GPU take a lot of processing power.

### BRIEF SUMMARY

A method for measuring metrics of a plurality of processors includes measuring, concurrently, a plurality of n metrics for a plurality of m processors executing portions of a workload in parallel. The measuring includes measuring, for a first processor of the plurality of m processors, a plurality of n metrics in a first sequence of a plurality of n sequences. The first sequence begins with a starting metric of the plurality of n metrics and ends with an nth metric of the plurality of n metrics. The measuring also includes measuring, for each remaining processor of the plurality of m processors, the plurality of n metrics in a sequence of the plurality of n sequences. Each progressive sequence of the plurality of n sequences begins with a progressive metric of the plurality of n metrics immediately subsequent to an immediately preceding sequence's starting metric of the plurality of n metrics. The method includes reporting the plurality of n metrics.

Embodiments of the present disclosure include an apparatus for measuring metrics of a plurality of processors. The apparatus includes a measurement module configured to measure, concurrently, a plurality of n metrics for a plurality of m processors executing portions of a workload in parallel. The measuring includes measuring, for a first processor of the plurality of m processors, a plurality of n metrics in a first sequence of a plurality of n sequences. The first sequence begins with a starting metric of the plurality of n metrics and ends with an nth metric of the plurality of n metrics. The measuring also includes measuring, for each remaining processor of the plurality of m processors, the plurality of n metrics in a sequence of the plurality of n sequences. Each progressive sequence of the plurality of n sequences begins with a progressive metric of the plurality of n metrics immediately subsequent to an immediately preceding sequence's starting metric of the plurality of n metrics. The apparatus includes a reporting module configured to report the plurality of n metrics. At least a portion of the modules include one or more of hardware circuits, programmable hardware circuits and executable code. The executable code is stored on one or more computer readable storage media.

Embodiments of the present disclosure also include a computer program product for measuring metrics of a plurality of processors that includes computer readable storage medium storing code. The code is configured to be executable by a processor to perform operations that include measuring, concurrently, a plurality of n metrics for a plurality of m processors executing portions of a workload in parallel. The measuring includes measuring, for a first processor of the plurality of m processors, a plurality of n metrics in a first sequence of a plurality of n sequences. The first sequence begins with a starting metric of the plurality of n metrics and ends with an nth metric of the plurality of n metrics. The measuring also includes measuring, for each remaining processor of the plurality of m processors, the plurality of n metrics in a sequence of the plurality of n sequences. Each progressive sequence of the plurality of n sequences begins with a progressive metric of the plurality of n metrics immediately subsequent to an immediately preceding sequence's starting metric of the plurality of n metrics. The operations include reporting the plurality of n metrics.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for measuring metrics of a plurality of processors, according to various embodiments;

FIG. 2 is a schematic block diagram illustrating a system for measuring metrics of a plurality of processors, according to various embodiments;

FIG. 3 is a schematic block diagram illustrating an apparatus for measuring metrics of a plurality of processors, according to various embodiments;

FIG. 4 is a schematic block diagram illustrating another apparatus for measuring metrics of a plurality of processors, according to various embodiments;

FIG. 5 is a schematic flow chart diagram illustrating a method for measuring metrics of a plurality of processors, according to various embodiments; and

FIG. 6 is a schematic flow chart diagram illustrating another method for measuring metrics of a plurality of processors, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Embodiments of the present disclosure include a method for measuring metrics of a plurality of processors. The method includes measuring, concurrently, a plurality of n metrics for a plurality of m processors executing portions of a workload in parallel. The measuring includes measuring, for a first processor of the plurality of m processors, a plurality of n metrics in a first sequence of a plurality of n sequences. The first sequence begins with a starting metric of the plurality of n metrics and ends with an nth metric of the plurality of n metrics. The measuring also includes measuring, for each remaining processor of the plurality of m processors, the plurality of n metrics in a sequence of the plurality of n sequences. Each progressive sequence of the plurality of n sequences begins with a progressive metric of the plurality of n metrics immediately subsequent to an immediately preceding sequence's starting metric of the plurality of n metrics. The method includes reporting the plurality of n metrics.

In some embodiments, a second sequence of the plurality of n sequences at a second processor begins with a second metric of the plurality of n metrics and ends with the first metric. In some embodiments, each subsequent sequence of the n sequences of a next processor of the m processors starts with a next metric with respect to a starting metric of the previous sequence of the previous processor and upon reaching the nth metric starts with the first metric and subsequent metrics to form a sequence with n metrics.

In some embodiments, reporting the plurality of n metrics includes concurrently reporting measurements of the m processors of the n metrics as the metrics are being recorded at the m processors. In some embodiments, an nth sequence of the plurality of n sequences begins with the nth metric of the plurality of n metrics, proceeds with the first metric immediately following the nth metric, and ends with an (n−1)th metric of the plurality of n metrics. In some embodiments, measuring, for each of the plurality of m processors and in a sequence of the plurality of n sequences, the plurality of metrics includes measuring each metric of the plurality of n metrics one measurement at a time for a processor of the plurality of m processors.

In some embodiments, each processor of the plurality of m processors includes one of a central processing unit (CPU), a graphics processing unit (GPU), and an accelerator. In some embodiments, the plurality of n metrics include: utilization, a performance-related metric, power consumption, temperature, humidity, memory bandwidth, memory usage, frame rate, and/or clock speed. In some embodiments, reporting the plurality of n metrics includes reporting information about the workload along with the n metrics, transmitting the metrics to a user, displaying the metrics on an electronic display, transmitting the metrics over a management network to a system administrator, and/or storing the metrics in a location accessible to a system administrator for later analysis.

Embodiments of the present disclosure include an apparatus for measuring metrics of a plurality of processors. The apparatus includes a measurement module configured to measure, concurrently, a plurality of n metrics for a plurality of m processors executing portions of a workload in parallel. The measuring includes measuring, for a first processor of the plurality of m processors, a plurality of n metrics in a first sequence of a plurality of n sequences. The first sequence begins with a starting metric of the plurality of n metrics and ends with an nth metric of the plurality of n metrics. The measuring also includes measuring, for each remaining processor of the plurality of m processors, the plurality of n metrics in a sequence of the plurality of n sequences. Each progressive sequence of the plurality of n sequences begins with a progressive metric of the plurality of n metrics immediately subsequent to an immediately preceding sequence's starting metric of the plurality of n metrics. The apparatus includes a reporting module configured to report the plurality of n metrics. At least a portion of the modules include one or more of hardware circuits, programmable hardware circuits and executable code. The executable is code stored on one or more computer readable storage media.

In some embodiments, a second sequence of the plurality of n sequences at a second processor begins with a second metric of the plurality of n metrics and ends with the first metric. In some embodiments, each subsequent sequence of the n sequences of a next processor of the m processors starts with a next metric with respect to a starting metric of the previous sequence of the previous processor and upon reaching the nth metric starts with the first metric and subsequent metrics to form a sequence with n metrics.

In some embodiments, the reporting module is configured to concurrently report measurements of the m processors of the n metrics as the measurement module is recording metrics at the m processors.

In some embodiments, an nth sequence of the plurality of n sequences begins with the nth metric of the plurality of n metrics, proceeds with the first metric immediately following the nth metric, and ends with an (n−1)th metric of the plurality of n metrics. In some embodiments, measuring, for each of the plurality of m processors and in a sequence of the plurality of n sequences, the plurality of n metrics includes measuring each metric of the plurality of n metrics one metric at a time for a processor of the plurality of m processors. In some embodiments, each processor of the plurality of m processors includes one of a central processing unit (“CPU”), a graphics processing unit (GPU), and an accelerator. In some embodiments, the plurality of n metrics includes: utilization, a performance-related metric, power consumption, temperature, humidity, memory bandwidth, memory usage, frame rate, and/or clock speed. In some embodiments, the reporting module includes: a workload module configured to reporting information about the workload along with the n metrics, a transmitting module configured to transmit the metrics to a user, a display module configured to display the metrics on an electronic display, an administrative transmitting module configured to transmit the metrics over a management network to a system administrator, and/or a storing module configured to store the metrics in a location accessible to a system administrator for later analysis.

Embodiments of the present disclosure include a computer program product for measuring metrics of a plurality of processors that includes computer readable storage medium storing code. The code is configured to be executable by a processor to perform that include measuring, concurrently, a plurality of n metrics for a plurality of m processors executing portions of a workload in parallel. The measuring includes measuring, for a first processor of the plurality of m processors, a plurality of n metrics in a first sequence of a plurality of n sequences. The first sequence begins with a starting metric of the plurality of n metrics and ends with an nth metric of the plurality of n metrics. The measuring also includes measuring, for each remaining processor of the plurality of m processors, the plurality of n metrics in a sequence of the plurality of n sequences. Each progressive sequence of the plurality of n sequences begins with a progressive metric of the plurality of n metrics immediately subsequent to an immediately preceding sequence's starting metric of the plurality of n metrics. The operations include reporting the plurality of n metrics.

In some embodiments, a second sequence of a plurality of n sequences at a second processor begins with a second metric of the plurality of n metrics and ends with the first metric.

Executing portions of a workload in parallel using multiple processors, such as graphics processing units (“GPU”s) can help to improve efficiency and capacity. Taking measurements of certain metrics for those processors as they are executing the workload can help to ensure good performance. Access to updated measurements for each of the metrics throughout the entire workload process can help to provide an accurate picture of performance. On the other hand, measuring multiple metrics for a given processor at the same time can consume a high measure of bandwidth. As such, embodiments of the present disclosure includes methods and apparatuses for measuring metrics in a manner that helps to reduce the overhead associated with concurrently measuring multiple metrics for a given processor while still providing a relatively comprehensive picture of performance.

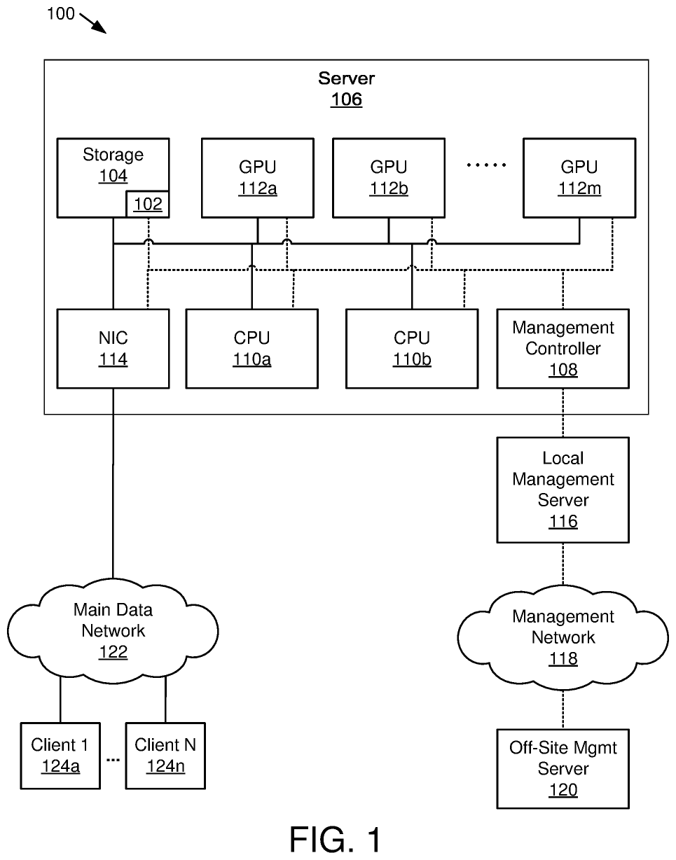

FIG. 1 is a schematic block diagram illustrating a system 100 for measuring metrics for a number of processors executing portions of a workload in parallel, according to various embodiments. The system 100 includes computing devices, such as a server 106 that operate to process workloads using parallel processing. In some embodiments, the server 106 includes a number of processors 112a-112m (generically or collectively “112”) that execute the workload using parallel processing.

In some examples, the server 106 includes a number of CPUs 110 (e.g., CPU 110a and CPU 110b) which are separate from the processors 112. Typically, the CPUs 110 manage execution of the workloads. In some embodiments, the server 106 includes a management controller 108 and a tracer apparatus 102. In some embodiments, the server 106 includes non-volatile data storage 104, and the non-volatile data storage 104 includes the tracer apparatus 102. In other embodiments, the tracer apparatus 102 is located elsewhere within the server 106 or accessible to the server 106, such as in non-volatile data storage in a storage area network (“SAN”) accessible to the server 106. In some embodiments, the server 106 is connected to a main data network 122 and/or other networks, such as a SAN, via a network interface card (“NIC”) 114 of the server 106.

The term “GPU 112” is used in some places herein to refer to the processors 112. However, those of skill in the art will appreciate that the embodiments of the present disclosure are not limited to the processors 112 being GPUs. In some embodiments, the processors 112 are CPUs, GPUs, accelerators, or other processor types. In some embodiments, the processors 112 are configured to execute portions of a workload in parallel. In some embodiments, the tracer apparatus 102 is configured to measure a plurality of metrics for each processor 112 as they are executing a workload. In some examples, the tracer apparatus 102 is configured to measure each of the metrics sequentially for a given processor 112. In some embodiments, the sequence of metrics for each processor 112 is offset from the preceding sequence in a manner that enables the tracer apparatus 102 to measure a given metric for at least one processor 112 at all times during execution of the workload. In addition, by offsetting measurement of the metrics, in some embodiments, at any given time the tracer apparatus 102 is able to measure as many metrics as there are processors 112 operating in parallel. The tracer apparatus 102 is described in more detail below.

The server 106, in some embodiments, includes a management controller 108 configured to manage and access various components of the server 106 via a management network 118. The management controller 108, in some embodiments, is referred to as a baseboard management controller (“BMC”). In other embodiments, the management controller 108 is an Xclarity® Controller (“XCC”) by Lenovo®, an Intel® AMT (Active Management Technology), or a controller with similar functionality. In some embodiments, the management controller 108 monitors internal physical variables in the server 106, GPUs 112, CPUs 110, non-volatile storage 104, the NIC 114, and other computing devices, such as temperature, humidity, power supply voltage, fan speeds, communication parameters, operating system (“OS”) functions, and the like and communicates metrics and other data to the local management server 116. In some embodiments, the management controller 108 measures and stores power consumption data, utilization data, operational data and other metering data of the server 106.

In other examples, the local management server 116, through the management controller 108, deploys instructions, software, firmware, etc. to deploy a virtual machine (“VM”) managed by a hypervisor in the server 106. In some embodiments, at least one of the CPUs 110 includes a hypervisor. In some embodiments, instructions, software, firmware, etc. from the local management server 116 allocates server resources to the VM, initiates an OS instance in the VM, etc. One of skill in the art will recognize other ways that a local management server 116 functions with respect to the server 106 and other computing devices. In some examples, the local management server 116 is an Xclarity® Administrator (“XCA”) that manages several servers 106 and associated management controllers 108.

The local management server 116 connects to the server 106 via the management controller 108 over a management network 118. In some embodiments, the system 100 includes a single local management server 116 for a customer location, which may be a datacenter. In other embodiments, the system 100 includes multiple local management servers 116, such as one for each group of servers 106. In some embodiments, the local management server 116 is in communication with an off-site management server 120 over the management network 118. In other embodiments, the off-site management server 120 is for a company that monitors and repairs the server 106. In other embodiments, a system does not include a local management server 116 and instead the server 106 connects directly with an off-site management server 120.

In some embodiments, the management network 118 is separate from a main data network 122 connecting the server 106 and clients 124. In some embodiments, the main data network 122 carries much more data than the management network 118 and has a bandwidth capable of handling data traffic between the clients 124 and/or a customer datacenter at a customer location. In some embodiments, the management network 118 is secure and includes a firewall capable of limiting external traffic to communication with a system administrator over the off-site management server 120. In other embodiments, the off-site management server 120 communicates with the local management server 116 over the main data network 122 using secure communications, such as over a tunnel, a virtual private network (“VPN”), etc.

In some embodiments, the management network 118 includes local area network (“LAN”), a wide area network (“WAN”), a fiber network, a wireless connection, a cellular network, etc. and may also include a combination of network types. In some embodiments, the main data network 122 is local area network (“LAN”), a wide area network (“WAN”), a fiber network, a wireless connection, a cellular network, the Internet, etc. and may also include a combination of network types. In some embodiments, the management network 118 and the main data network 122 include data cables, servers, switches, routers, and/or other networking equipment.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

In some examples, the server 106 includes non-volatile data storage 104, which may include a management controller 108. In some examples, the non-volatile data storage 104 includes non-volatile storage devices and may include solid-state storage devices, hard disk drives, optical disks, or other non-volatile storage technology. In some embodiments, the non-volatile data storage 104 is accessible by the client 124. In some embodiments, the non-volatile data storage 104 is accessible by the client 124 over the main data network 122, which is connected to a network interface card (“NIC”) 114 of the server 106. In other embodiments, the system 100 includes non-volatile storage external to the server 106. Such external non-volatile storage may be accessible through a SAN.

Although FIG. 1 shows two CPUs 110 on the server 106, embodiments of the present disclosure are not so limited. In some embodiments, the server 106 includes only one CPU 110 and in other embodiments the server 106 includes three or more CPUs 110. Additionally, although FIG. 1 shows three GPUs 112, embodiments of the present disclosure are not so limited. In some embodiments, the server 106 includes two GPUs 112 or four or more GPUs 112.

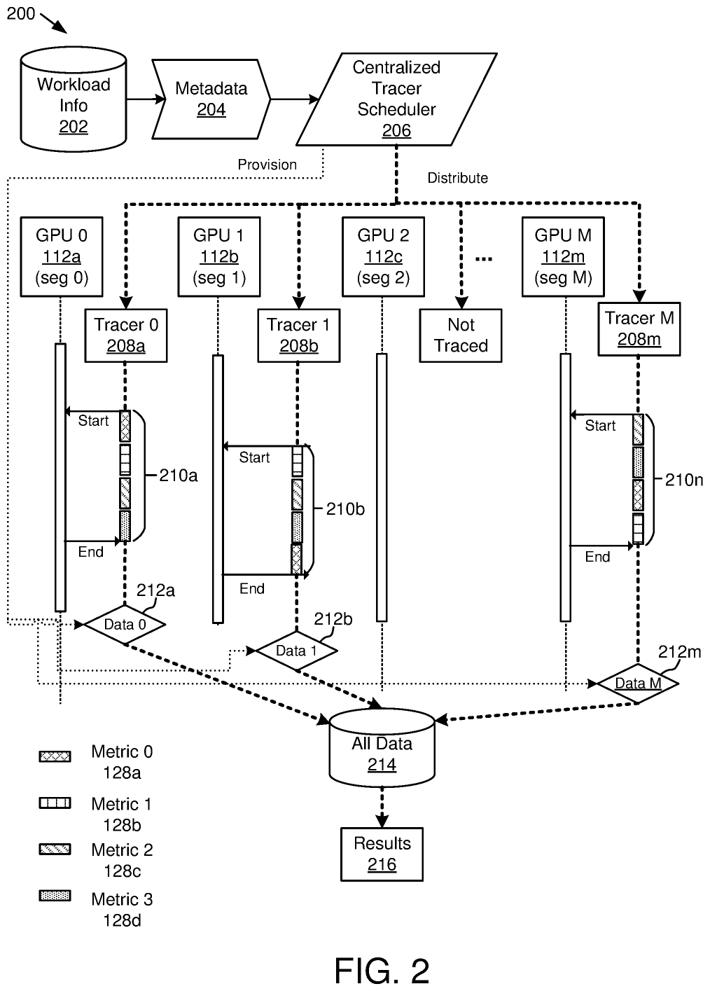

FIG. 2 is a schematic block diagram illustrating a partial system 200 for measuring metrics of a plurality of processors 112, according to various embodiments. In some embodiments, the partial system 200 is an embodiment of the system 100. As shown in FIG. 2, in some embodiments, the partial system 200 includes a number of tracers 208, each of which are configured by a centralized tracer scheduler 206 to measure metrics 128 of a GPU 112 sequentially in a corresponding sequence 210. For example, Tracer 0 208a is configured to measure metrics 128 in a first sequence 210a that begins with Metric 0 128a and proceeds sequentially through Metric 1 128b, Metric 2 128c, and Metric 3 128n. In some embodiments, each tracer 208 measures only one metric 128 at a given time in a work cycle, thus helping to reduce overhead for the partial system 200. In some embodiments, the partial system 200 is configured to generate less than 10 gigabytes (“GB”) of data for the server 106 for every second of a tracing period. Other tracers measure multiple metrics at once and generate considerably more data than 10 GB per second. As used herein, the term “tracing period” refers to a total period of time during which at least one tracer 208 is collecting metrics 128 for a workload.

In some embodiments, the centralized tracer scheduler 206 is part of the tracer apparatus 102. In some embodiments, the centralized tracer scheduler 206 is configured to distribute a workload into segments seg 0, seg 1, seg 2, . . . seg M. In some embodiments, a quantity of segments is equal to a quantity m of processors 112. In some embodiments, the centralized tracer scheduler 206 segments the workload, for example into threads, and/or assigns a tracer 208 to the workload based at least in part on workload information 202. In some embodiments, the workload information 202 is stored on a workload management system, a configuration database, or the like. In some embodiments, the centralized tracer scheduler 206 leverages metadata 204 when configuring the tracers 208. In some embodiments, the metadata 204 helps to define when a tracer 208 is activated and/or which metrics to measure.

In some embodiments, the centralized tracer scheduler 206 is configured to schedule the metrics 128 of the tracers 208 such that each tracer 208 is measuring only one metric 128 at a given time within the work period. In some embodiments, the centralized tracer scheduler 206 is configured to schedule the tracers 208 such that each metric 128 is being measured by precisely one tracer 208 in any given time within a work period. As used herein, the term “work period” refers to a period of time during which the GPUs are executing the workload. As used herein, the term “sequence cycle” refers to a period of time during which a tracer 208 measures each metric 128 for a given GPU 112 in a sequence 210 exactly once, which is denoted by the “start” and “end” points in FIG. 2. In some examples, a work period includes multiple sequence cycles for each sequence 210.

The examples depicted in FIG. 2 include tracer 0 208a that starts a measurement sequence 210a with metric 0 128a, then metric 1 128b, then metric 2 128c, then metric 3 128d. The tracer 2 208b has a different sequence 208b that starts with metric 1 128b, then metric 2 128c, then metric 3 128d, and then metric 0 128a. GPU 2 112c is not traced so GPU M 112m includes tracer M is depicted with a sequence 210n starting with metric 2 128c, then metric 3 128d, then metric 0 128a, then metric 1 128b. Thus, where the sequences 210 align, at any given time three different metrics 128 are measured by the three depicted GPUs 112a, 112b, and 112m with tracers 208. The second sequence 210b is depicted as starting later than the first sequence 210a and the third sequence 210m to indicate an embodiment where threads don't start all at the same time. In some embodiments, the tracers 208 rotate through the metrics 128 numerous times while maintaining being offset sequences 210 to have multiple metrics 210 available at any given time.

In some embodiments, there are more metrics 128 than processors 112 so that only a partial set of metrics 128 is measurable at one time. In other embodiments, the number of metrics 128 equals the number of processors 112. In other embodiments, there are more processors 112 than metrics 210 and some sequences 210 may be repeated. In some embodiments, the length of time to measure a particular metric 128 is chosen to adequately rotate through the sequences 210 during workload execution. In some embodiments, the length of time to measure the various metrics is equal so that the sequences remain relatively in sync. While FIG. 2 depicts four metrics 128a-d and three GPUs, other numbers of metrics 128 may be chosen (e.g., n metrics) and other numbers of processors 112 may be chosen (e.g., m processors 112).

In some embodiments, the centralized tracer scheduler 206 is configured to embed workload information 202 for a segment of the workload into each of the tracers. In some embodiments, the centralized tracer scheduler 206 is configured to select metrics 128 to be measured for each GPU 112. In some embodiments, the centralized tracer scheduler 206 is configured to initiate the tracers 208 at the same and/or at different times. In some embodiments, the tracers 208 are activated by a user. In some embodiments, the tracers 208 are initiated automatically with the initiation of the workload segment for the corresponding GPU 112. In some examples, the centralized tracer scheduler 206 triggers each of the tracers 208 in parallel. In some embodiments, the centralized tracer scheduler 206 configures each tracer 208 to initiate at a given step within the workload. In some embodiments, the centralized tracer scheduler 206 is configured to disable tracers 208 asynchronously.

In some embodiments, the centralized tracer scheduler 206 is configured to assign a sequence 210 to a tracer 208 for a particular GPU 112. In some embodiments, the centralized tracer scheduler 206 is configured to select a sequence 210 and tracer 208 pairing based at least in part on workload information 202. In some embodiments, the centralized tracer scheduler 206 includes an artificial intelligence (“AI”) model and is configured to perform at least one of the following based at least in part on the results 216 of the metrics 128: segment the workload, assign sequences 210 to tracers 208, initiate tracers 208, and/or disable tracers 208.

In some examples, the GPUs 112 are each executing portions of the same workload in parallel. In other embodiments, the GPUs 112 are executing similar workloads concurrently. In some embodiments, the tracer apparatus 102 operates under an assumption that the GPUs 112 are working in a similar fashion. As such, although only one GPU 112 is being measured for a given metric 128 at a given time within the work period, the measurements for that metric 128 are somewhat informative for the entire system 100, since each of the GPUs 112 are executing similar workloads. In some examples, each GPU 112 is executing a workload “thread,” or a set of instructions of a workload that can be executed independently from other sets in the workload. In some examples, each GPU 112 executes a portion of a workload repetitively.

In some examples, the workload is a training workload. In some embodiments, the training workload is a training process for an AI model, such as a deep learning model and/or a machine learning model. In some embodiments, the model is a Generative Pre-trained Transformer (“GPT”) model. In some embodiments, the model includes: recurrent neural networks (“RNNs”), convolutional neural networks (“CNNs”), and/or other types of models. In some embodiments, the training workload is distributed amongst the GPUs 112 to help reduce training time. In some embodiments, a copy of a model is replicated on each GPU 112, and each GPU 112 works to update the model by working on a batch of data from the training dataset while the tracers 208 measure the metrics 128 for the GPUs 112. In other embodiments, each GPU 112 works on a different portion of a model while the tracers 208 measure the metrics 128. In some embodiments, each GPU 112 is processing different fragments of data from a machine learning model.

Although FIG. 2 illustrates the start and end times for the sequences 210 being offset from each other, embodiments of the present disclosure are not so limited. In some embodiments, the sequences 210 each start at the same time or substantially the same time. In some embodiments, the total sequence time from the start to the end is the same or substantially the same for each sequence 210. In some embodiments, the workload is launched on the GPUs 112 asynchronously. In other embodiments, the workload is launched on the GPUs at the same time.

In some embodiments, the metrics 128 are taken using various resources. In some embodiments, the resources used for a metric 128 include resources used for another metric 128. As such, measuring the metrics 128 sequentially can help to avoid resource conflicts. In some embodiments, the centralized tracer scheduler 206 is configured to schedule and/or order the sequences 210 such that two metrics 128 using the same resources do not take place at the same time for a given GPU 112. Such resources include, in some embodiments, sensors built into the GPU 112 and configured to measure temperature, voltage, and/or clock speed. In some embodiments, such resources include graphics cards providing access to data via APIs. In some embodiments, the resources include metering configured to measure current and/or voltage across various elements of the GPU 112.

Although FIG. 2 illustrates all of the metrics 128 being traced for each of the GPUs 112, embodiments of the present disclosure are not so limited. In some embodiments, the metrics 128 in a first sequence 210a are different from the metrics 128 in a second sequence 210b. In some embodiments, a sequence 210 includes less than all of the metrics 128. In some embodiments, the tracer apparatus 102 is configured to receive and/or generate a configuration profile for each of the GPUs 112, specifying which metrics 128 are to be traced for that particular GPU 112. In some embodiments, the configuration profile is editable by a user (e.g., the clients 124) such that the metrics 128 and/or sequences 210 are customizable for each GPU 112. In some examples, each tracer 208 only measures a subset of the metrics 128.

In some embodiments, each tracer 208 is configured to collect data 212 for a given processor 112, which data reflects the metrics 128 made for that processor. In some embodiments, a first tracer 208a corresponding to first GPU 112a collects the plurality of metrics 128 in a first dataset 212a. Some embodiments include aggregating the data 212 from each processor 112 into a common dataset of all data 214. Embodiments of the present disclosure include reporting that data 214 as results 216 of the tracer 208 operations.

In some embodiments, the quantity n of sequences 210 is equal to the quantity n of metrics 128. As shown in FIG. 2, in some embodiments, the quantity m of processors 112 is equal to the quantity n of sequences 210 and metrics 128. However, embodiments of the present disclosure are not so limited. Rather, in some embodiments, the quantity n of sequences 210 and of metrics 128 is less than the quantity m of processors 112. In some embodiments, a given sequence 210 is used to measure metrics 128 for two or more processors 112.

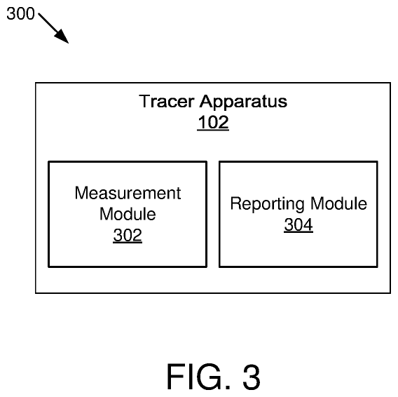

FIG. 3 is a schematic block diagram illustrating an apparatus 300 for measuring metrics of a plurality of processors, according to various embodiments. The apparatus 300 includes a tracer apparatus 102, as shown in FIG. 1, with a measurement module 302 and a reporting module 304, which are described below. In some embodiments, all or a portion of the apparatus 300 is implemented with executable code stored on a computer readable storage media. In other embodiments, all or a portion of the apparatus 300 is implemented using hardware circuits and/or a programmable hardware device.

The measurement module 302 is configured to measure, concurrently, a plurality of n metrics 128 for a plurality of m processors 112 executing segments of a workload in parallel. In some embodiments, the plurality of n metrics 128 includes: utilization, a performance-related metric, power consumption, temperature, humidity, memory bandwidth, memory usage, frame rate, floating-point operations per second (“FLOPS”), clock speed, or the like. In some embodiments, the measurement module 302 includes measuring the metrics 128 via the tracers 208. The measuring includes measuring, for a first processor 112a of the plurality of m processors 112, a plurality of n metrics 128 in a first sequence 210a of a plurality of n sequences 210.

The first sequence 210a begins with a starting metric 128a of the plurality of n metrics 128 and ends with an nth metric 128n of the plurality of n metrics 128. In some embodiments, during at least one point in the work period in which the first tracer 208a is measuring the first metric 128a, no other tracers 208b, . . . , 208n are measuring that metric 128a.

The measurement module 302 is also configured to measure, for each remaining processor of the plurality of m processors 112, the plurality of n metrics 128 in a sequence of the plurality of n sequences 210. Each progressive sequence 210 of the plurality of n sequences 210 begins with a progressive metric 128 of the plurality of n metrics 128 immediately subsequent to an immediately preceding sequence's 210 starting measurement of the plurality of n metrics 128. For example, where a first sequence 210a starts with metric 0 128a, a second sequence 210b starts with metric 1 128b, the third sequence 210c starts with metric 2 128c, etc. until reaching the n sequences 210. Where there are more processors 112 than metrics 128, some sequences 210 may be repeated. Where there are more metrics 128 than processors 112, all n metrics may not be measured at any one time.

In some embodiments, the second tracer 208b measures the metrics 128 in a second sequence 210b that beings with the second metric 128b, proceeds throughout the second sequence 210b to the nth metric 128n, and ends with the first metric 128a. In other embodiments, the second tracer 208b begins with the nth metric 128n, proceeds to the first metric 128a and measures the remaining metrics sequentially. In some examples, each metric 128 is a starting metric for at least one of the sequences 210 and is an ending metric for at least one of the sequences 210. In some examples, the measurement module 302 is configured to measure the metrics 128 across the GPUs 112 in a “round robin” manner. In some embodiments, the centralized tracer scheduler 206 schedules the tracers 208 to measure the metrics 128 in a round robin manner.

In some embodiments, each subsequent sequence 210 of a next processor 112 starts with a next metric 128 with respect to a starting metric 128 of the previous sequence 210 of the previous processor 112 and upon reaching the nth metric 128n starts with the first metric 128a and subsequent metrics 128 to form a sequence 210 with n metrics 128. In some embodiments, an nth sequence 210n begins with the nth metric 128n, proceeds with the first metric 128a immediately following the nth metric 128n, and ends with an (n−1)th metric 128c of the plurality of n metrics 128. In some embodiments, measuring, for each of the plurality of m processors 112 and in a sequence of the plurality of n sequences 210, the plurality of n metrics 128 includes measuring each metric 128 one metric 128 at a time for a processor 112.

The reporting module 304 is configured to report the plurality of n metrics 128. In some embodiments, reporting the plurality of n metrics 128 includes reporting the results 216. In some embodiments, the reporting the results 216 includes reporting the results 216 to a client 124. In some embodiments, the reporting module 304 is configured to report the results 216 in real-time as the tracers 208 are taking measurements of the metrics 128. In some embodiments, the reporting module 304 is configured to concurrently report measurements of the n metrics 128 of the m processors 112 of the n metrics 128 as the measurement module 302 is recording metrics at the m processors 112.

At least a portion of the modules include hardware circuits, programmable hardware circuits and/or executable code. The executable code is stored on one or more computer readable storage media.

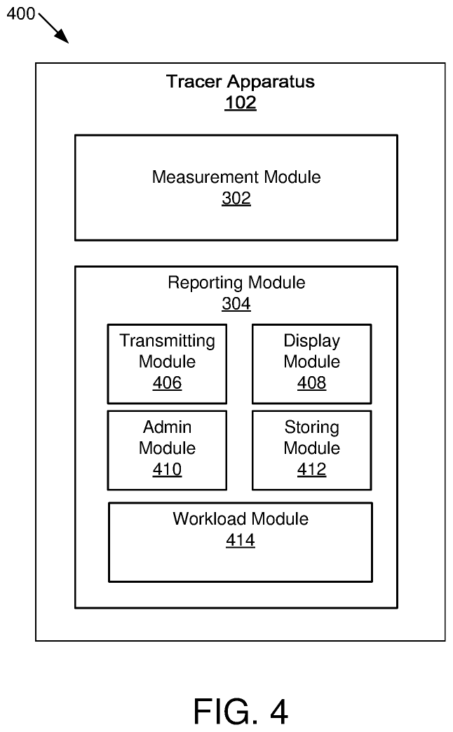

FIG. 4 is a schematic block diagram illustrating another apparatus 400 for measuring metrics of a plurality of processors, according to various embodiments. The apparatus 400 includes a tracer apparatus 102 as shown in FIGS. 1 and 3. The apparatus 400 includes a measurement module 302 and a reporting module 304, which are substantially similar to those described above with regards to the apparatus 300 of FIG. 3. In various embodiments, the apparatus 300 includes a transmitting module 406, display module 408, administrative transmitting module 410, a storing module 412, and/or a workload module 414, which are described below. In some embodiments, the apparatus 400 is implemented in a similar way as the apparatus 300 of FIG. 3.

In some embodiments, the reporting module 304 includes a workload module 414 configured to report information about the workload along with the n metrics 128. In some embodiments, the workload module 414 combines information about the workload with the metrics. In other embodiments, the workload module 414 combines information about the workload with the metrics in a format where the metrics are correlated with different phases of execution of the workload.

In some embodiments, the reporting module 304 includes a transmitting module 406 configured to transmit the metrics 128 to a user. The user may be a person at a datacenter console, a system administrator or the like. In some embodiments, the reporting module 304 includes a display module 408 configured to display the metrics 128 on an electronic display. The electronic display may be at a console of a datacenter, of a desktop computer, on a laptop computer, at a remote server, at a client 124, or the like. In some embodiments, the reporting module 304 includes an admin module 410 configured to transmit the metrics 128 over a management network 118 to a system administrator. In some embodiments, the admin module 410 uses the management controller 108. In some embodiments, the reporting module 304 includes a storing module 412 configured to store the metrics in a location accessible to the system 100, to a system administrator, or to another user for later analysis.

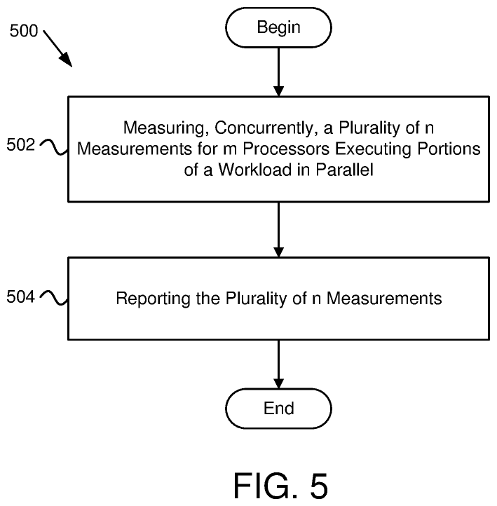

FIG. 5 is a schematic flow chart diagram illustrating a method 500 for measuring metrics of a plurality of processors, according to various embodiments. The method 500 begins and measures 502, concurrently, a plurality of n metrics 128 for a plurality of m processors 112 executing portions of a workload in parallel. The measuring 502 includes measuring, for a first processor 112a of the plurality of m processors 112, a plurality of n metrics 128 in a first sequence 210a of a plurality of n sequences 210. The first sequence 210a begins with a starting metric 128a of the plurality of n metrics 128 and ends with an nth metric 128n of the plurality of n metrics 128. The measuring 502 also includes measuring, for each remaining processor 112b, . . . , 112m of the plurality of m processors 112, the plurality of n metrics 128 in a sequence of the plurality of n sequences 210. Each progressive sequence 210 of the plurality of n sequences 210 begins with a progressive metric 128 of the plurality of n metrics 128 immediately subsequent to an immediately preceding sequence 210's starting metric 128 of the plurality of n metrics 128. The method 500 reports 504 the plurality of n metrics 128, and the method 500 ends. In various embodiments, all or a portion of the method 500 is implemented using the measurement module 302 and/or the reporting module 304.

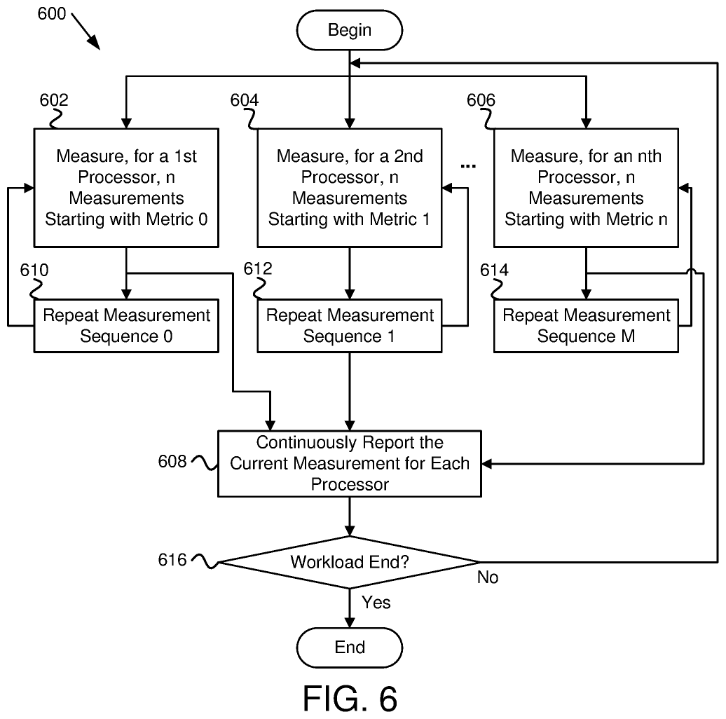

FIG. 6 is a schematic flow chart diagram illustrating another method 600 for measuring metrics of a plurality of processors, according to various embodiments, the method 600 begins and measures 602, for a first processor 112a, n metrics 128 in a first sequence 210a starting with metric 0 128a progressing to metric n 128n. The method 600 concurrently measures 604, for a second processor 112b and in the second sequence 210b, the n metrics 128 starting with metric 1 128b, then metric 2 128c, etc. to metric n 128n. The second sequence 210b then ends with metric 0 128a. The method 600 concurrently measures 606, for an nth processor 112, n metrics 128 in a sequence 210n. The sequence 210n beings with metric n 128n, then measures 606 metric 0 128a, then metric 1 128b, etc. to the (n−1) metric.

In some embodiments, each subsequent sequence 210 of the n sequences 210 of a next processor 112 of the m processors 112 starts with a next metric 128 with respect to a starting metric 128 of the previous sequence 210 of the previous processor 112. Upon reaching the nth metric, the sequence 210 starts with metric 0 128a and subsequent metrics 128 to form a sequence 210 with n metrics 128.

In some embodiments, the method 600 includes continuously reporting 608 the current metric 128 for each processor 112. In some embodiments, reporting 608 the plurality of n metrics 128 includes concurrently reporting measurements of the m processors 112 of the n metrics 128 as the metrics 128 are being recorded at the m processors 112. In some embodiments, continuously reporting 608 the current metric 128 includes updating the results 216.

In some embodiments, reporting 608 the plurality of n metrics 128 includes reporting 608 information about the workload along with the n metrics 128, transmitting the metrics 128 to a user, displaying the metrics 128 on an electronic display, transmitting the metrics 128 over a management network 118 to a system administrator, and/or storing the metrics 128 in a location accessible to a system administrator for later analysis.

The method 600 repeats 610 the first sequence 210a, repeats 613 the second sequence 210b, etc. and repeats the mth sequence 210 while the workload is executing. The method 600 determines 616 whether the workload has finished processing. If the method 600 determines 616 that the workload has not finished processing, the method 600 returns and continues to measure 602, 604, 606 metrics 128. If the method 600 determines 616 that the workload has finished processing, the method 600 ends. In various embodiments, all or a portion of the method 600 is implemented using the measurement module 302, the reporting module 304, the transmitting module 406, the display module 408, the administrative transmitting module 410, the storing module 412, and/or the workload module 414.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
measuring, concurrently, a plurality of n metrics for a plurality of m processors executing portions of a workload in parallel, the measuring comprising:
measuring, for a first processor of the plurality of m processors, a plurality of n metrics in a first sequence of a plurality of n sequences, the first sequence beginning with a starting metric of the plurality of n metrics and ending with an nth metric of the plurality of n metrics; and
measuring, for each remaining processor of the plurality of m processors, the plurality of n metrics in a sequence of the plurality of n sequences, each progressive sequence of the plurality of n sequences beginning with a progressive metric of the plurality of n metrics immediately subsequent to an immediately preceding sequence's starting metric of the plurality of n metrics; and
reporting measurement of the plurality of the n metrics.

2. The method of claim 1, wherein a second sequence of the plurality of n sequences at a second processor begins with a second metric of the plurality of n metrics and ends with the starting metric.

3. The method of claim 2, wherein each subsequent sequence of the n sequences of a next processor of the m processors starts with a next metric with respect to a starting metric of a previous sequence of a previous processor and upon reaching the nth metric starts with a first metric and subsequent metrics to form a sequence with n metrics.

4. The method of claim 1, wherein reporting the measurement the plurality of n metrics comprises concurrently reporting measurements of the m processors of the n metrics as the measurements are being recorded at the m processors.

5. The method of claim 1, wherein an nth sequence of the plurality of n sequences begins with the nth metric of the plurality of n metrics, proceeds with the first metric immediately following the nth metric, and ends with an (n−1)th metric of the plurality of n metrics.

6. The method of claim 1, wherein measuring, for each of the plurality of m processors and in a sequence of the plurality of n sequences, the plurality of n metrics comprises measuring each metric.

7. The method of claim 1, wherein each processor of the plurality of m processors comprises one of a central processing unit (CPU), a graphics processing unit (GPU), and an accelerator.

8. The method of claim 1, wherein the plurality of n metrics comprise: utilization, a performance-related metric, power consumption, temperature, humidity, memory bandwidth, memory usage, frame rate, and/or clock speed.

9. The method of claim 1, wherein reporting the plurality of n metrics comprises reporting information about the workload along with the n metrics, transmitting the plurality of n metrics to a user, displaying the metrics on an electronic display, transmitting the metrics over a management network to a system administrator, and/or storing the metrics in a location accessible to a system administrator for later analysis.

10. An apparatus comprising:
a measurement module configured to measure, concurrently, a plurality of n metrics for a plurality of m processors executing portions of a workload in parallel, the measuring comprising:
measuring, for a first processor of the plurality of m processors, a plurality of n metrics in a first sequence of a plurality of n sequences, the first sequence beginning with a starting metric of the plurality of n metrics and ending with an nth metric of the plurality of n metrics; and
measuring, for each remaining processor of the plurality of m processors, the plurality of n metrics in a sequence of the plurality of n sequences, each progressive sequence of the plurality of n sequences beginning with a progressive metric of the plurality of n metrics immediately subsequent to an immediately preceding sequence's starting metric of the plurality of n metrics; and
a reporting module configured to report the plurality of n metrics,
wherein at least a portion of said modules comprise one or more of hardware circuits, programmable hardware circuits and executable code, the executable code stored on one or more computer readable storage media.

11. The apparatus of claim 10, wherein a second sequence of the plurality of n sequences at a second processor begins with a second metric of the plurality of n metrics and ends with the first metric.

12. The apparatus of claim 10, wherein each subsequent sequence of the n sequences of a next processor of the plurality of m processors starts with a next metric with respect to a starting metric of a previous sequence of a previous processor and upon reaching the nth metric starts with a first metric and subsequent metrics to form a sequence with n metrics.

13. The apparatus of claim 10, wherein the reporting module is configured to concurrently report measurements of the m processors of the n metrics as the measurement module is recording metrics at the m processors.

14. The apparatus of claim 10, wherein an nth sequence of the plurality of n sequences begins with the nth metric of the plurality of n metrics, proceeds with the first metric immediately following the nth metric, and ends with an (n−1)th metric of the plurality of n metrics.

15. The apparatus of claim 10, wherein measuring, for each of the plurality of m processors and in a sequence of the plurality of n sequences, the plurality of n metrics comprises measuring each metric of the plurality of n metrics one measurement at a time for a processor of the plurality of m processors.

16. The apparatus of claim 10, wherein each processor of the plurality of m processors comprises one of a central processing unit (CPU), a graphics processing unit (GPU), and an accelerator.

17. The apparatus of claim 10, wherein the plurality of n metrics comprise: utilization, a performance-related metric, power consumption, temperature, humidity, memory bandwidth, memory usage, frame rate, and/or clock speed.

18. The apparatus of claim 10, wherein the reporting module comprises: a workload module configured to reporting information about the workload along with the n metrics, a transmitting module configured to transmit the metrics to a user, a display module configured to display the metrics on an electronic display, an administrative transmitting module configured to transmit the metrics over a management network to a system administrator, and/or a storing module configured to store the metrics in a location accessible to a system administrator for later analysis.

19. A computer program product, the computer program product comprising a computer readable storage medium storing code, the code being configured to be executable by a processor to perform operations comprising:
measuring, concurrently, a plurality of n metrics for a plurality of m processors executing portions of a workload in parallel, the measuring comprising:
measuring, for a first processor of the plurality of m processors, a plurality of n metrics in a first sequence of a plurality of n sequences, the first sequence beginning with a starting metric of the plurality of n metrics and ending with an nth metric of the plurality of n metrics; and
measuring, for each remaining processor of the plurality of m processors, the plurality of n metrics in a sequence of the plurality of n sequences, each progressive sequence of the plurality of n sequences beginning with a progressive metric of the plurality of n metrics immediately subsequent to an immediately preceding sequence's starting metric of the plurality of n metrics; and
reporting the plurality of n metrics.

20. The computer program product of claim 19, wherein a second sequence of a plurality of n sequences at a second processor begins with a second metric of the plurality of n metrics and ends with the first metric.
